(19) United States
(12) Patent Application Publication
(10) Pub. No.: US 2012/0158388 A1
(43) Pub. Date: Jun. 21, 2012

(54) MODELING SHOCK PRODUCED BY WELL PERFORATING

(75) Inventors: John RODGERS, Roanoke, TX (US); Marco SERRA, Winterthur (CH); David SWENSON, Crossroads, TX (US); Timothy S. GLENN, Dracut, MA (US)

(73) Assignee: HALLIBURTON ENERGY SERVICES, INC., Houston, TX (US)

(21) Appl. No.: 13/210,303

(22) Filed: Aug. 15, 2011

(30) Foreign Application Priority Data
Dec. 17, 2010 (US) PCT/US10/61104

(51) Int. Cl. G06G 7/48

(52) U.S. Cl. 703/10

(57) ABSTRACT

A method of utilizing a shock model for prediction of perforating effects can include recording measurements of the perforating effects on an actual perforating string in a wellbore, adjusting the shock model so that predictions of the perforating effects output by the shock model substantially match the measurements of the perforating effects, and causing the adjusted shock model to predict the perforating effects for a proposed perforating string. A method of predicting perforating effects on a perforating string in a wellbore can include inputting a three dimensional well model and a three dimensional model of the perforating string into a shock model, and causing the shock model to predict the perforating effects on the perforating string.

### CROSS-REFERENCE TO RELATED APPLICATION

This application claims the benefit under 35 USC §119 of the filing date of International Application Serial No. PCT/US10/61104, filed 17 Dec. 2010. The entire disclosure of this prior application is incorporated herein by this reference.

### BACKGROUND

The present disclosure relates generally to equipment utilized and operations performed in conjunction with a subterranean well and, in an embodiment described herein, more particularly provides for modeling shock produced by well perforating.

Attempts have been made to model the effects of shock due to perforating. It would be desirable to be able to predict shock due to perforating, for example, to prevent unsetting a production packer, to prevent failure of a perforating gun body, and to otherwise prevent or at least reduce damage to various components of a perforating string.

Unfortunately, past shock models have not been able to predict shock effects in axial, bending and torsional directions, and to apply these shock effects to three dimensional structures, thereby predicting stresses in particular components of the perforating string. One hindrance to the development of such a shock model has been the lack of satisfactory measurements of the strains, loads, stresses, pressures, and/or accelerations, etc., produced by perforating. Such measurements can be useful in verifying a shock model and refining its output.

Therefore, it will be appreciated that improvements are needed in the art. These improvements can be used, for example, in designing new perforating string components which are properly configured for the conditions they will experience in actual perforating situations, and in preventing damage to any equipment.

### SUMMARY

In carrying out the principles of the present disclosure, a method is provided which brings improvements to the art of predicting shock produced by well perforating. One example is described below in which the method is used to adjust predictions made by a shock model, in order to make the predictions more precise. Another example is described below in which the shock model is used to optimize a design of a perforating string.

A method of utilizing a shock model for prediction of perforating effects is provided by the disclosure below. In one example, the method can include recording measurements of the perforating effects on an actual perforating string in a wellbore; adjusting the shock model so that predictions of the perforating effects output by the shock model substantially match the measurements of the perforating effects; and causing the adjusted shock model to predict the perforating effects for a proposed perforating string.

Also described below is a method of predicting perforating effects on a perforating string in a wellbore. The method can include inputting a three dimensional well model and a three dimensional model of the perforating string into a shock model; and causing the shock model to predict the perforating effects on the perforating string.

These and other features, advantages and benefits will become apparent to one of ordinary skill in the art upon careful consideration of the detailed description of representative embodiments of the disclosure hereinbelow and the accompanying drawings, in which similar elements are indicated in the various figures using the same reference numbers.

### BRIEF DESCRIPTION OF THE DRAWINGS

FIG. 1 is a schematic partial cross-sectional view of a well system and associated method which can embody principles of the present disclosure.

FIGS. 2-5 are schematic views of a shock sensing tool which may be used in the system and method of FIG. 1.

FIGS. 6-8 are schematic views of another configuration of the shock sensing tool.

FIG. 9 is a schematic flowchart for the method.

FIG. 10 is a schematic block diagram of a shock model, along with its inputs and outputs.

### DETAILED DESCRIPTION

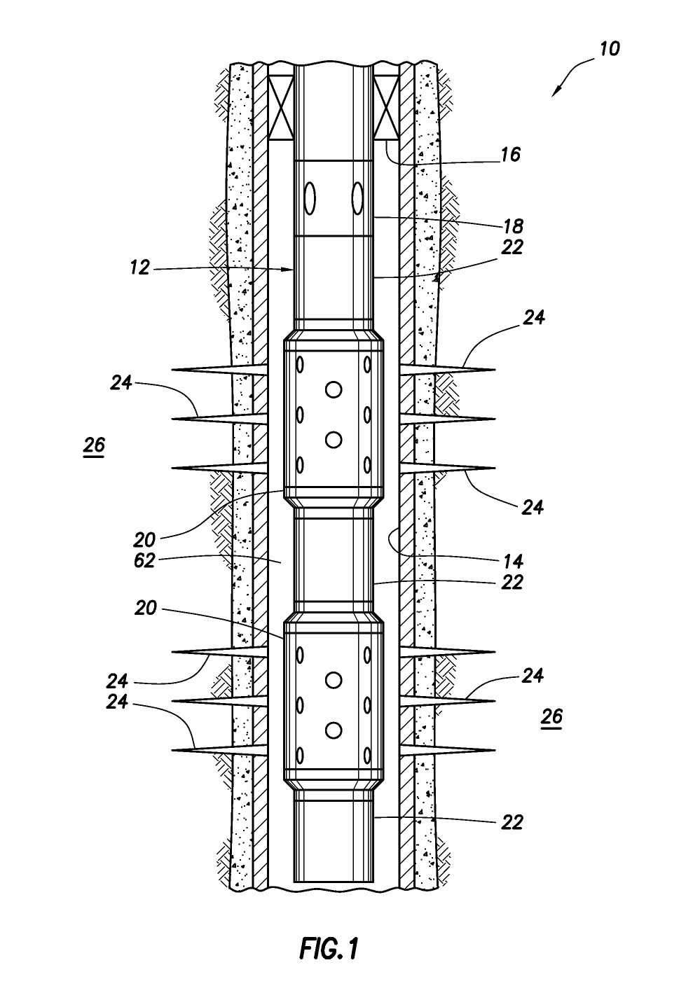

Representatively illustrated in FIG. 1 is a well system 10 and associated method which can embody principles of the present disclosure. In the well system 10, a perforating string 12 is installed in a wellbore 14. The depicted perforating string 12 includes a packer 16, a firing head 18, perforating guns 20 and shock sensing tools 22.

In other examples, the perforating string 12 may include more or less of these components. For example, well screens and/or gravel packing equipment may be provided, any number (including one) of the perforating guns 20 and shock sensing tools 22 may be provided, etc. Thus, it should be clearly understood that the well system 10 as depicted in FIG. 1 is merely one example of a wide variety of possible well systems which can embody the principles of this disclosure.

A shock model can use a three dimensional model of the perforating string 12 and wellbore 14 to realistically model the physical behavior of the system 10 during a perforating event. Preferably, the shock model will predict at least bending, torsional and axial loading, as well as motion in all directions (three dimensional motion). The model can include predictions of casing contact and friction, and the loads that result from it.

In a preferred example, detailed finite element models of the components of the perforating string 12 enable a higher fidelity prediction of stresses in the components. Wellbore pressure dynamics and communication with a formation can also be incorporated into the model.

The shock model is preferably calibrated using actual perforating string loads and accelerations, as well as wellbore pressures, collected from one or more of the shock sensing tools 22. Measurements taken by the shock sensing tools 22 can be used to verify the predictions made by the shock model, and to make adjustments to the shock model, so that future predictions are more accurate.

The shock sensing tool 22 can be as described in the International patent application entitled, “Sensing Shock During Well Perforating,” filed on even date herewith. That patent application discloses that the shock sensing tools 22 can be interconnected in various locations along the perforating string 12.

One advantage of interconnecting the shock sensing tools 22 below the packer 16 and in close proximity to the perforating guns 20 is that more accurate measurements of strain and acceleration at the perforating guns can be obtained. Pressure and temperature sensors of the shock sensing tools 22 can also sense conditions in the wellbore 14 in close proximity to perforations 24 immediately after the perforations are formed, thereby facilitating more accurate analysis of characteristics of an earth formation 26 penetrated by the perforations.

A shock sensing tool 22 interconnected between the packer 16 and the upper perforating gun 20 can record the effects of perforating on the perforating string 12 above the perforating guns. This information can be useful in preventing unsetting or other damage to the packer 16, firing head 18, etc., due to detonation of the perforating guns 20 in future designs.

A shock sensing tool 22 interconnected between perforating guns 20 can record the effects of perforating on the perforating guns themselves. This information can be useful in preventing damage to components of the perforating guns 20 in future designs.

A shock sensing tool 22 can be connected below the lower perforating gun 20, if desired, to record the effects of perforating at this location. In other examples, the perforating string 12 could be stabbed into a lower completion string, connected to a bridge plug or packer at the lower end of the perforating string, etc., in which case the information recorded by the lower shock sensing tool 22 could be useful in preventing damage to these components in future designs.

Viewed as a complete system, the placement of the shock sensing tools 22 longitudinally spaced apart along the perforating string 12 allows acquisition of data at various points in the system, which can be useful in validating a model of the system. Thus, collecting data above, between and below the guns, for example, can help in an understanding of the overall perforating event and its effects on the system as a whole.

The information obtained by the shock sensing tools 22 is not only useful for future designs, but can also be useful for current designs, for example, in post-job analysis, formation testing, etc. The applications for the information obtained by the shock sensing tools 22 are not limited at all to the specific examples described herein.

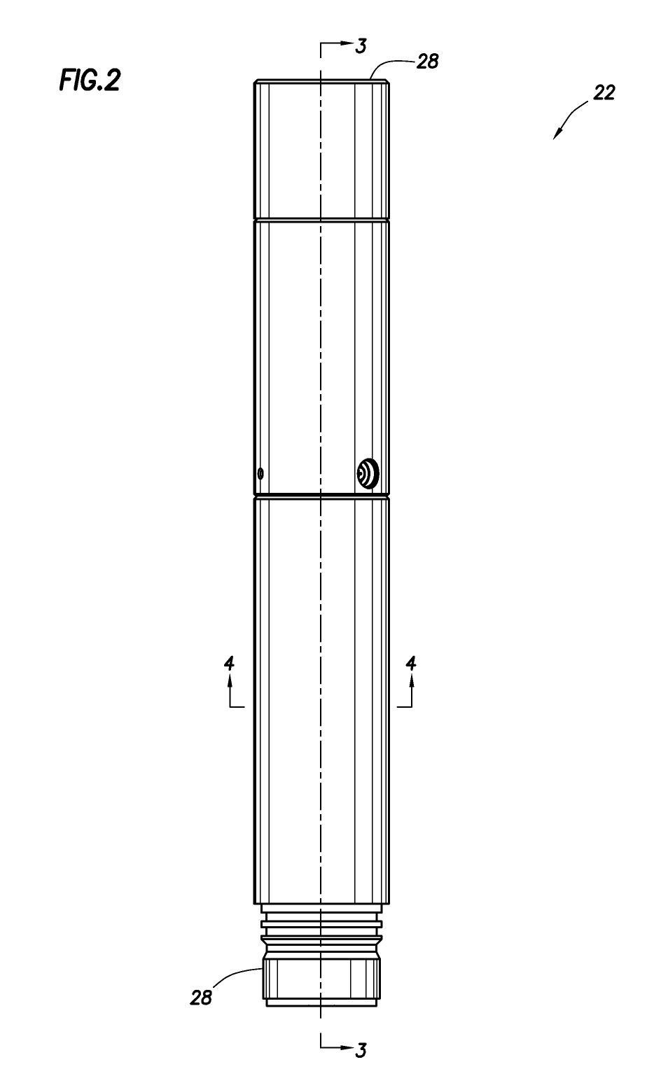

Referring additionally now to FIGS. 2-5, one example of the shock sensing tool 22 is representatively illustrated. As depicted in FIG. 2, the shock sensing tool 22 is provided with end connectors 28 (such as, perforating gun connectors, etc.) for interconnecting the tool in the perforating string 12 in the well system 10. However, other types of connectors may be used, and the tool 22 may be used in other perforating strings and in other well systems, in keeping with the principles of this disclosure.

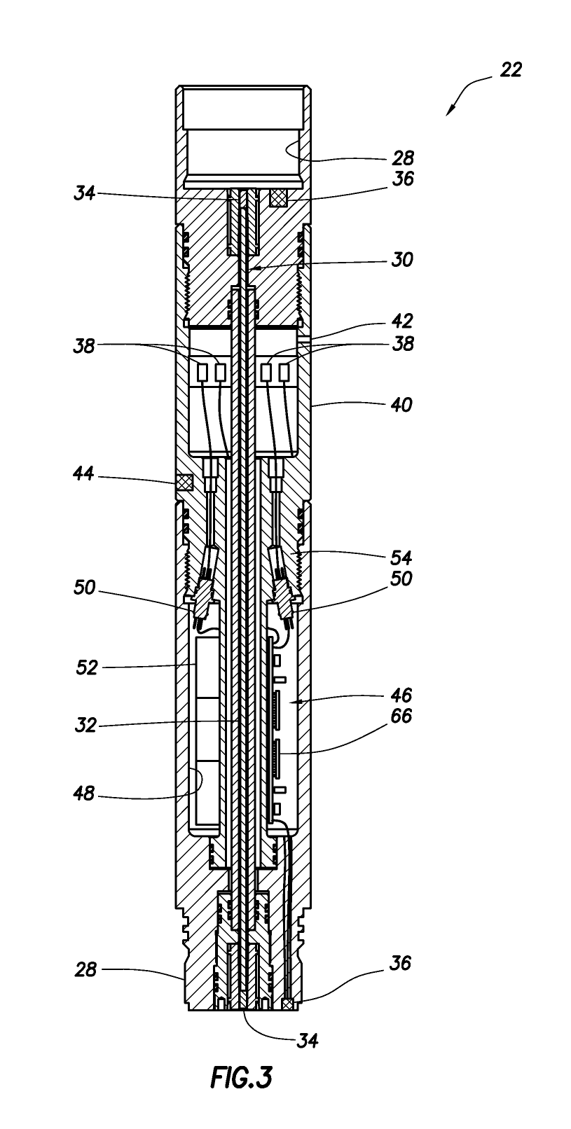

In FIG. 3, a cross-sectional view of the shock sensing tool 22 is representatively illustrated. In this view, it may be seen that the tool 22 includes a variety of sensors, and a detonation train 30 which extends through the interior of the tool.

The detonation train 30 can transfer detonation between perforating guns 20, between a firing head (not shown) and a perforating gun, and/or between any other explosive components in the perforating string 12. In the example of FIGS. 2-5, the detonation train 30 includes a detonating cord 32 and explosive boosters 34, but other components may be used, if desired.

One or more pressure sensors 36 may be used to sense pressure in perforating guns, firing heads, etc., attached to the connectors 28. Such pressure sensors 36 are preferably ruggedized (e.g., to withstand ˜20000 g acceleration) and capable of high bandwidth (e.g., >20 kHz). The pressure sensors 36 are preferably capable of sensing up to ˜60 ksi (˜414 MPa) and withstanding ˜175 degrees C. Of course, pressure sensors having other specifications may be used, if desired.

Strain sensors 38 are attached to an inner surface of a generally tubular structure 40 interconnected between the connectors 28. The structure 40 is preferably pressure balanced, i.e., with substantially no pressure differential being applied across the structure.

In particular, ports 42 are provided to equalize pressure between an interior and an exterior of the structure 40. By equalizing pressure across the structure 40, the strain sensor 38 measurements are not influenced by any differential pressure across the structure before, during or after detonation of the perforating guns 20.

The strain sensors 38 are preferably resistance wire-type strain gauges, although other types of strain sensors (e.g., piezoelectric, piezoresistive, fiber optic, etc.) may be used, if desired. In this example, the strain sensors 38 are mounted to a strip (such as a KAPTON™ strip) for precise alignment, and then are adhered to the interior of the structure 40.

Preferably, four full Wheatstone bridges are used, with opposing 0 and 90 degree oriented strain sensors being used for sensing axial and bending strain, and +/−45 degree gauges being used for sensing torsional strain.

The strain sensors 38 can be made of a material (such as a KARMA™ alloy) which provides thermal compensation, and allows for operation up to ˜150 degrees C. Of course, any type or number of strain sensors may be used in keeping with the principles of this disclosure.

The strain sensors 38 are preferably used in a manner similar to that of a load cell or load sensor. A goal is to have all of the loads in the perforating string 12 passing through the structure 40 which is instrumented with the sensors 38.

Having the structure 40 fluid pressure balanced enables the loads (e.g., axial, bending and torsional) to be measured by the sensors 38, without influence of a pressure differential across the structure. In addition, the detonating cord 32 is housed in a tube 33 which is not rigidly secured at one or both of its ends, so that it does not share loads with, or impart any loading to, the structure 40.

A temperature sensor 44 (such as a thermistor, thermocouple, etc.) can be used to monitor temperature external to the tool. Temperature measurements can be useful in evaluating characteristics of the formation 26, and any fluid produced from the formation, immediately following detonation of the perforating guns 20. Preferably, the temperature sensor 44 is capable of accurate high resolution measurements of temperatures up to ˜170 degrees C.

Another temperature sensor (not shown) may be included with an electronics package 46 positioned in an isolated chamber 48 of the tool 22. In this manner, temperature within the tool 22 can be monitored, e.g., for diagnostic purposes or for thermal compensation of other sensors (for example, to correct for errors in sensor performance related to temperature change). Such a temperature sensor in the chamber 48 would not necessarily need the high resolution, responsiveness or ability to track changes in temperature quickly in wellbore fluid of the other temperature sensor 44.

The electronics package 46 is connected to at least the strain sensors 38 via pressure isolating feed-throughs or bulkhead connectors 50. Similar connectors may also be used for connecting other sensors to the electronics package 46. Batteries 52 and/or another power source may be used to provide electrical power to the electronics package 46.

The electronics package 46 and batteries 52 are preferably ruggedized and shock mounted in a manner enabling them to withstand shock loads with up to ˜10000 g acceleration. For example, the electronics package 46 and batteries 52 could be potted after assembly, etc.

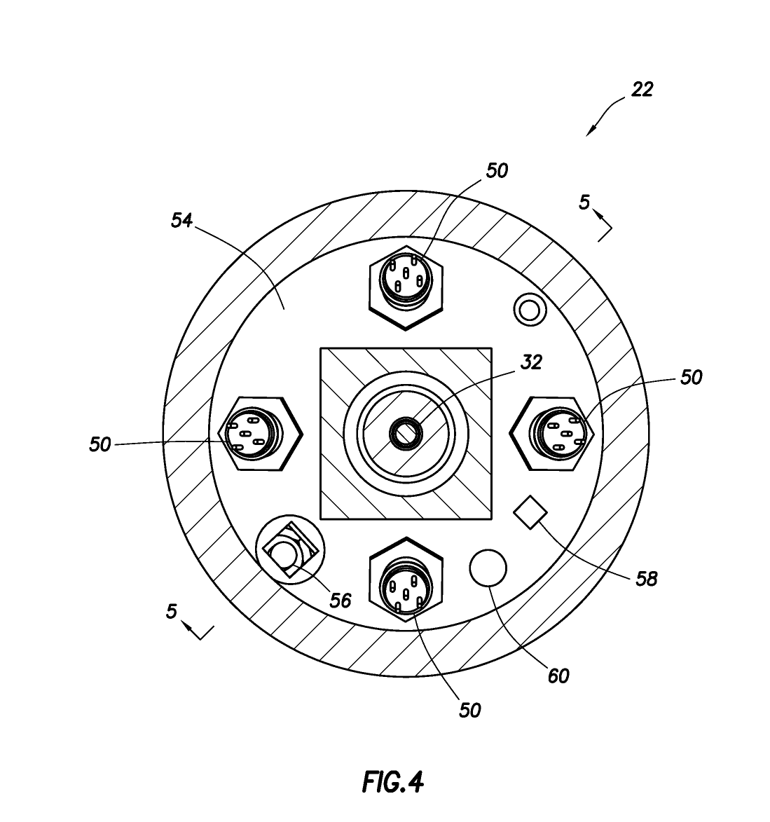

In FIG. 4 it may be seen that four of the connectors 50 are installed in a bulkhead 54 at one end of the structure 40. In addition, a pressure sensor 56, a temperature sensor 58 and an accelerometer 60 are preferably mounted to the bulkhead 54.

The pressure sensor 56 is used to monitor pressure external to the tool 22, for example, in an annulus 62 formed radially between the perforating string 12 and the wellbore 14 (see FIG. 1). The pressure sensor 56 may be similar to the pressure sensors 36 described above. A suitable pressure transducer is the Kulite model HKM-15-500.

The temperature sensor 58 may be used for monitoring temperature within the tool 22. This temperature sensor 58 may be used in place of, or in addition to, the temperature sensor described above as being included with the electronics package 46.

The accelerometer 60 is preferably a piezoresistive type accelerometer, although other types of accelerometers may be used, if desired. Suitable accelerometers are available from Endevco and PCB (such as the PCB 3501A series, which is available in single axis or triaxial packages, capable of sensing up to ˜60000 g acceleration).

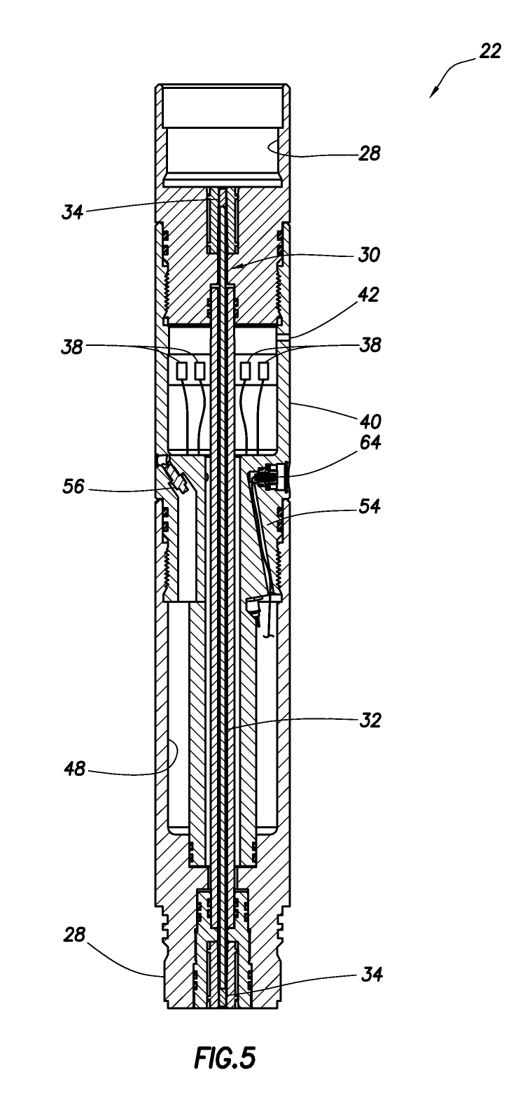

In FIG. 5, another cross-sectional view of the tool 22 is representatively illustrated. In this view, the manner in which the pressure transducer 56 is ported to the exterior of the tool 22 can be clearly seen. Preferably, the pressure transducer 56 is close to an outer surface of the tool, so that distortion of measured pressure resulting from transmission of pressure waves through a long narrow passage is prevented.

Also visible in FIG. 5 is a side port connector 64 which can be used for communication with the electronics package 46 after assembly. For example, a computer can be connected to the connector 64 for powering the electronics package 46, extracting recorded sensor measurements from the electronics package, programming the electronics package to respond to a particular signal or to “wake up” after a selected time, otherwise communicating with or exchanging data with the electronics package, etc.

Note that it can be many hours or even days between assembly of the tool 22 and detonation of the perforating guns 20. In order to preserve battery power, the electronics package 46 is preferably programmed to “sleep” (i.e., maintain a low power usage state), until a particular signal is received, or until a particular time period has elapsed.

The signal which “wakes” the electronics package 46 could be any type of pressure, temperature, acoustic, electromagnetic or other signal which can be detected by one or more of the sensors 36, 38, 44, 56, 58, 60. For example, the pressure sensor 56 could detect when a certain pressure level has been achieved or applied external to the tool 22, or when a particular series of pressure levels has been applied, etc. In response to the signal, the electronics package 46 can be activated to a higher measurement recording frequency, measurements from additional sensors can be recorded, etc.

As another example, the temperature sensor 58 could sense an elevated temperature resulting from installation of the tool 22 in the wellbore 14. In response to this detection of elevated temperature, the electronics package 46 could “wake” to record measurements from more sensors and/or higher frequency sensor measurements.

As yet another example, the strain sensors 38 could detect a predetermined pattern of manipulations of the perforating string 12 (such as particular manipulations used to set the packer 16). In response to this detection of pipe manipulations, the electronics package 46 could “wake” to record measurements from more sensors and/or higher frequency sensor measurements.

The electronics package 46 depicted in FIG. 3 preferably includes a non-volatile memory 66 so that, even if electrical power is no longer available (e.g., the batteries 52 are discharged), the previously recorded sensor measurements can still be downloaded when the tool 22 is later retrieved from the well. The non-volatile memory 66 may be any type of memory which retains stored information when powered off. This memory 66 could be electrically erasable programmable read only memory, flash memory, or any other type of non-volatile memory. The electronics package 46 is preferably able to collect and store data in the memory 66 at >100 kHz sampling rate.

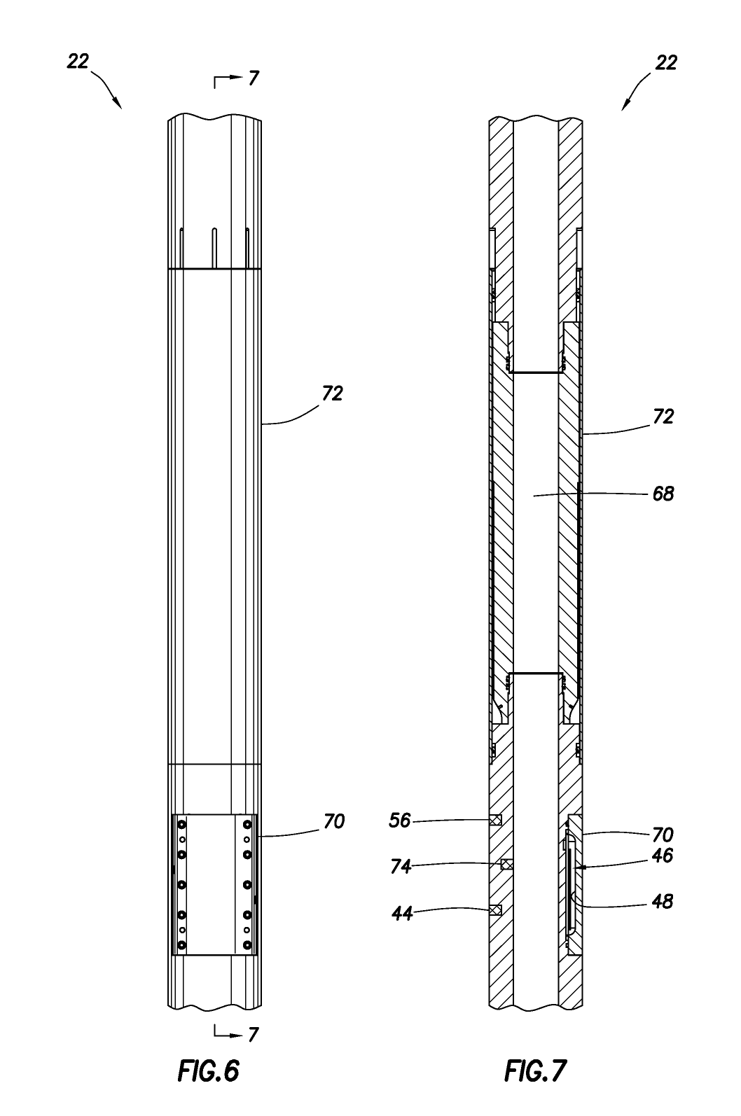

Referring additionally now to FIGS. 6-8, another configuration of the shock sensing tool 22 is representatively illustrated. In this configuration, a flow passage 68 (see FIG. 7) extends longitudinally through the tool 22. Thus, the tool 22 may be especially useful for interconnection between the packer 16 and the upper perforating gun 20, although the tool 22 could be used in other positions and in other well systems in keeping with the principles of this disclosure.

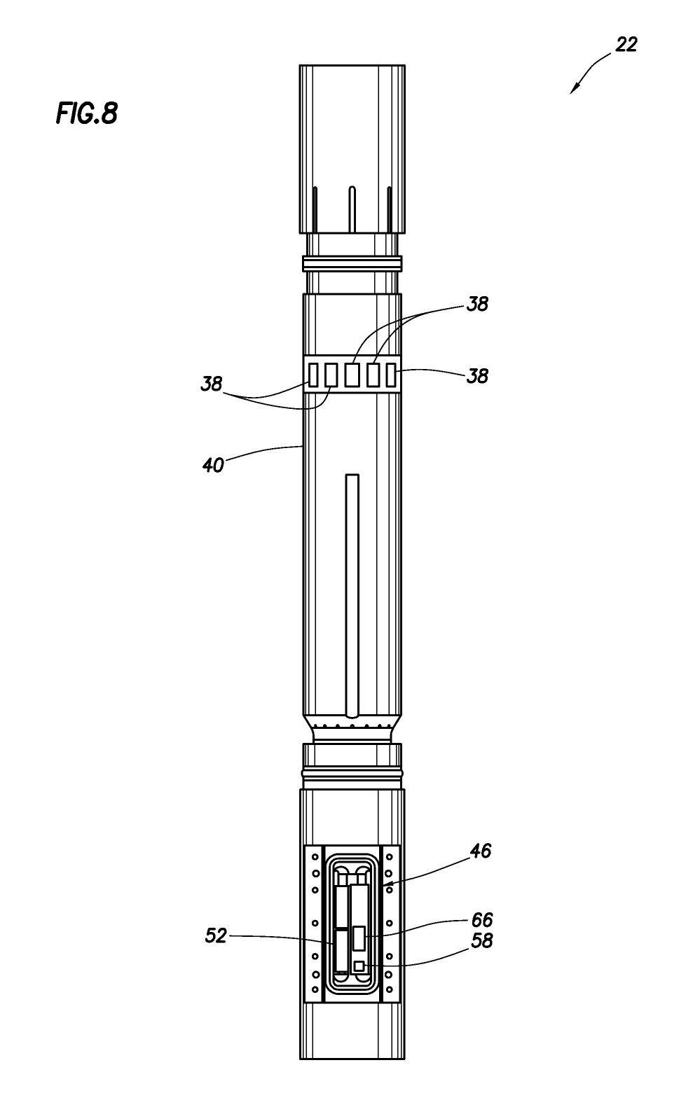

In FIG. 6 it may be seen that a removable cover 70 is used to house the electronics package 46, batteries 52, etc. In FIG. 8, the cover 70 is removed, and it may be seen that the temperature sensor 58 is included with the electronics package 46 in this example. The accelerometer 60 could also be part of the electronics package 46, or could otherwise be located in the chamber 48 under the cover 70.

A relatively thin protective sleeve 72 is used to prevent damage to the strain sensors 38, which are attached to an exterior of the structure 40 (see FIG. 8, in which the sleeve is removed, so that the strain sensors are visible). Although in this example the structure 40 is not pressure balanced, another pressure sensor 74 (see FIG. 7) can be used to monitor pressure in the passage 68, so that any contribution of the pressure differential across the structure 40 to the strain sensed by the strain sensors 38 can be readily determined (e.g., the effective strain due to the pressure differential across the structure 40 is subtracted from the measured strain, to yield the strain due to structural loading alone).

Note that there is preferably no pressure differential across the sleeve 72, and a suitable substance (such as silicone oil, etc.) is preferably used to fill the annular space between the sleeve and the structure 40. The sleeve 72 is not rigidly secured at one or both of its ends, so that it does not share loads with, or impart loads to, the structure 40.

Any of the sensors described above for use with the tool 22 configuration of FIGS. 2-5 may also be used with the tool configuration of FIGS. 6-8.

In general, it is preferable for the structure 40 (in which loading is measured by the strain sensors 38) to experience dynamic loading due only to structural shock by way of being pressure balanced, as in the configuration of FIGS. 2-5. However, other configurations are possible in which this condition can be satisfied. For example, a pair of pressure isolating sleeves could be used, one external to, and the other internal to, the load bearing structure 40 of the FIGS. 6-8 configuration. The sleeves could encapsulate air at atmospheric pressure on both sides of the structure 40, effectively isolating the structure from the loading effects of differential pressure. The sleeves should be strong enough to withstand the pressure in the well, and may be sealed with o-rings or other seals on both ends. The sleeves may be structurally connected to the tool at no more than one end, so that a secondary load path around the strain sensors 38 is prevented.

Although the perforating string 12 described above is of the type used in tubing-conveyed perforating, it should be clearly understood that the principles of this disclosure are not limited to tubing-conveyed perforating. Other types of perforating (such as, perforating via coiled tubing, wireline or slickline, etc.) may incorporate the principles described herein. Note that the packer 16 is not necessarily a part of the perforating string 12.

With measurements obtained by use of shock sensing tools 22, a shock model can be precisely calibrated, so that it can be applied to proposed perforating system designs, in order to improve those designs (e.g., by preventing failure of, or damage to, any perforating system components, etc.), to optimize the designs in terms of performance, efficiency, effectiveness, etc., and/or to generate optimized designs.

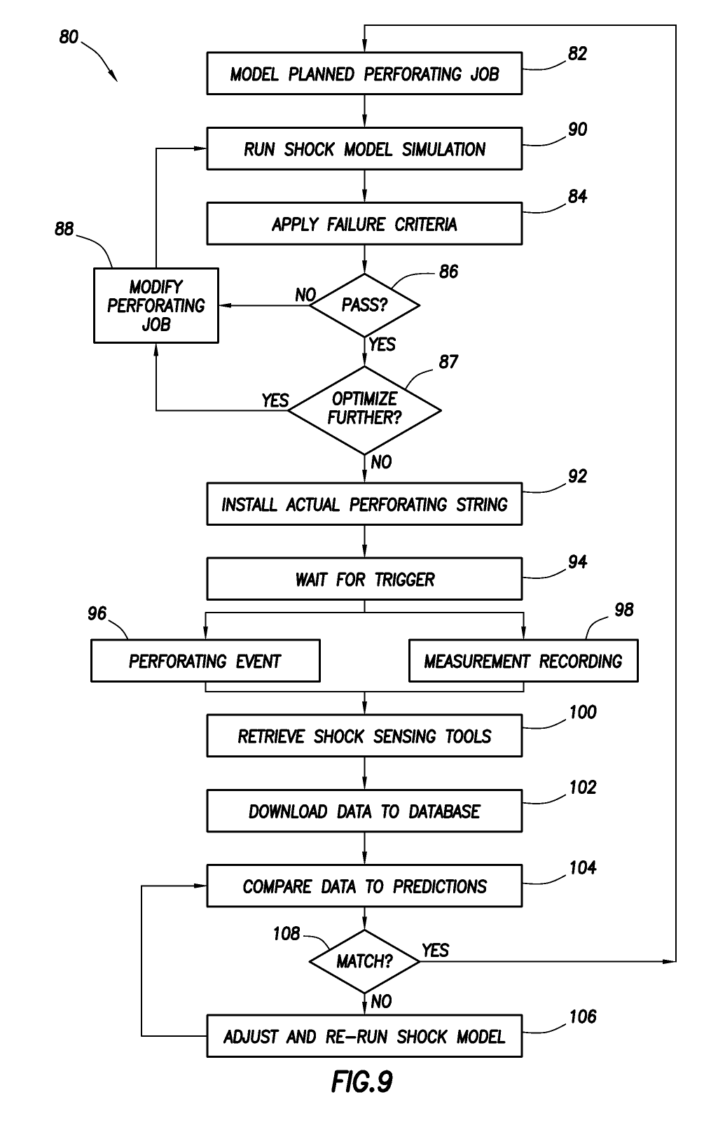

In FIG. 9, a flowchart for the method 80 is representatively illustrated. The method 80 depicted in flowchart form in FIG. 9 can be used with the system 10 described above, or it may be used with a variety of other systems.

In step 82, a planned or proposed perforating job is modeled. Preferably, at least the perforating string 12 and wellbore 14 are modeled geometrically in three dimensions, including material types of each component, expected wellbore communication with the formation 26 upon perforating, etc. Finite element models can be used for the structural elements of the system 10.

Suitable finite element modeling software is LS-DYNA™ available from Livermore Software Technology Corporation. This software can utilize shaped charge models, multiple shaped charge interaction models, flow through permeable rock models, etc.

In steps 90, 84, 86, 87, 88, the perforating string 12 is optimized using the shock model. Various metrics may be used for this optimization process. For example, performance, cost-effectiveness, efficiency, reliability, and/or any other metric may be maximized by use of the shock model.

Optimization may also include improving the safety margins for failure as a trade-off with other performance metrics. In one example, it may be desired to have tubing above the perforating guns 20 as short as practical, but failure risks may require that the tubing be longer. So there is a trade-off, and an accurate shock model can help in selecting an appropriate length for the tubing.

Optimization is an iterative process of running shock model simulations and modifying the perforating job design as needed to improve upon a valued performance metric. Each iteration of modifying the design influences the response of the system to shock and, thus, requires that the failure criteria be checked every iteration of the optimization process.

In step 90, the shock produced by the perforating string 12 and its effects on the various components of the perforating string are predicted by running a shock model simulation of the perforating job. For example, the perforating system can be input to the shock model to obtain a prediction of stresses, strains, pressures, loading, motion, etc., in the perforating string 12.

Based on the outcome of applying failure criteria to these predictions in step 84 and the desire to optimize the design further, the perforating string 12 can be modified in step 88 as needed to enhance the performance, cost-effectiveness, efficiency, reliability, etc., of the perforating system.

The modified perforating string 12 can then be input into the shock model to obtain another prediction, and another modification of the perforation string can be made based on the prediction. This process can be repeated as many times as needed to obtain an acceptable level of performance, cost-effectiveness, efficiency, reliability, etc., for the perforating system.

Once the perforating string 12 and overall perforating system are optimized, in step 92 an actual perforating string is installed in the wellbore 14. The actual perforating string 12 should be the same as the perforating string model, the actual wellbore 14 should be the same as the modeled wellbore, etc., used in the shock model to produce the prediction in step 90.

In step 94, the shock sensing tool(s) 22 wait for a trigger signal to start recording measurements. As described above, the trigger signal can be any signal which can be detected by the shock sensing tool 22 (e.g., a certain pressure level, a certain pattern of pressure levels, pipe manipulation, a telemetry signal, etc.).

In step 96, the perforating event occurs, with the perforating guns 20 being detonated, thereby forming the perforations 24 and initiating fluid communication between the formation 26 and the wellbore 14. Concurrently with the perforating event, the shock sensing tool(s) 22 in step 98 record various measurements, such as, strains, pressures, temperatures, accelerations, etc. Any measurements or combination of measurements may be taken in this step.

In step 100, the shock sensing tools 22 are retrieved from the wellbore 14. This enables the recorded measurement data to be downloaded to a database in step 102. In other examples, the data could be retrieved by telemetry, by a wireline sonde, etc., without retrieving the shock sensing tools 22 themselves, or the remainder of the perforating string 12, from the wellbore.

In step 104, the measurement data is compared to the predictions made by the shock model in step 90. If the predictions made by the shock model do not acceptably match the measurement data, appropriate adjustments can be made to the shock model in step 106 and a new set of predictions generated by running a simulation of the adjusted shock model. If the predictions made by the adjusted shock model still do not acceptably match the measurement data, further adjustments can be made to the shock model, and this process can be repeated until an acceptable match is obtained.

Once an acceptable match is obtained, the shock model can be considered calibrated and ready for use with the next perforating job. Each time the method 80 is performed, the shock model should become more adept at predicting loads, stresses, pressures, motions, etc., for a perforating system, and so should be more useful in optimizing the perforating string to be used in the system.

Over the long term, a database of many sets of measurement data and predictions can be used in a more complex comparison and adjustment process, whereby the shock model adjustments benefit from the accumulated experience represented by the database. Thus, adjustments to the shock model can be made based on multiple sets of measurement data and predictions.

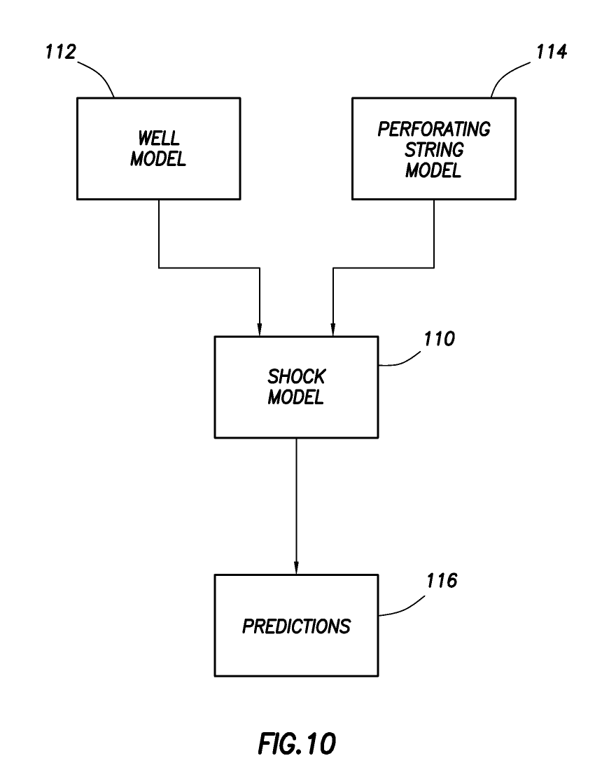

Referring additionally now to FIG. 10, a block diagram of the shock model 110 and associated well model 112, perforating string model 114 and output predictions 116 are representatively illustrated. As described above, the shock model 110 utilizes the model 112 of the well (including, for example, the geometry of the wellbore 14, the characteristics of the formation 26, the fluid in the wellbore, flow through permeable rock models, etc.) and the model 114 of the perforating string 12 (including, for example, the geometries of the various perforating string components, shaped charge models, shaped charge interaction models, etc.), in order to produce the predictions 116 of loads, stresses, pressures, motions, etc. in the well system 10.

The perforating string 12, wellbore 14 (including, e.g., casing and cement lining the wellbore), fluid in the wellbore, formation 26, and other well components are preferably precisely modeled in three dimensions in high resolution using finite element modeling techniques. For example, the perforating guns 20 can be modeled along with their associated gun body scallops, thread reliefs, etc.

Deviation of the wellbore 14 can be modeled. This is used in predicting contact loads, friction and other interactions between the perforating string 12 and the wellbore 14.

The fluid in the wellbore 14 can be modeled. The modeled wellbore fluid is the link between the pressures generated by the shaped charges, formation communication, and the perforating string 12 structural model. The wellbore fluid can be modeled in one dimension or, preferably, in three dimensions. Modeling of the wellbore fluid can also be described as a fluid-structure interaction model, a term that refers to the loads applied to the structure by the fluid.

Failures can also occur as a result of high pressures or pressure waves. So it is important for the model to predict the fluid behavior for the reasons that the fluid loads the structure and the fluid itself can damage the packer or casing directly.

A three dimensional shaped charge model can be used for predicting internal gun pressures and distributions, impact loads of charge cases on interiors of the gun bodies, charge interaction effects, etc.

The shock model 110 can include neural networks, genetic algorithms, and/or any combination of numerical methods to produce the predictions. One particular benefit of the method 80 described above is that the accuracy of the predictions 116 produced by the shock model 110 can be improved by utilizing the actual measurements of the effects of shock taken by the shock sensing tool(s) 22 during a perforating event. The shock model 110 is preferably validated and calibrated using the measurements of actual perforating effects by the shock sensing tool(s) 22 in the perforating string 12.

The shock model 110 and/or shock sensing tool 22 can be useful in failure investigation, that is, to determine why damage or failure occurred on a particular perforating job.

The shock model 110 can be used to optimize the perforating string 12 design, for example, to maximize performance, to minimize stresses, motion, etc., in the perforating string, to provide an acceptable margin of safety against structural damage or failure, etc.

In the application of failure criteria to the predictions generated by the shock model 110, typical metrics, such as material static yield strength, may be used and/or more complex parameters that relate to strain rate-dependent effects that affect crack growth may be used. Dynamic fracture toughness is a measure of crack growth under dynamic loading. Stress reversals result when loading shifts between compression and tension. Repeated load cycles can result in fatigue. Thus, the application of failure criteria may involve more than simply a stress versus strength metric.

The shock model 110 can incorporate other tools that may have more complex behavior that can affect the model's predictions. For example, advanced gun connectors have been modeled specifically because they exhibit a nonlinear behavior that has a large effect on predictions.

It may now be fully appreciated that the above disclosure provides several advancements to the art. The shock model 110 can be used to predict the effects of a perforating event on various components of the perforating string 14, and to investigate a failure of, or damage to, an actual perforating string. In the method 80 described above, the shock model 110 can also be used to optimize the design of the perforating string 14.

The above disclosure provides to the art a method 80 of utilizing a shock model 110 for prediction of perforating effects. The method 80 can include recording measurements of the perforating effects on an actual perforating string 12 in a wellbore 14; adjusting the shock model 110 so that predictions of the perforating effects output by the shock model 110 substantially match the measurements of the perforating effects; and causing the adjusted shock model 110 to predict the perforating effects for a proposed perforating string 12.

The recorded measurements may include axial, bending and torsional strain in the actual perforating string 12. The recorded measurements may also include pressure external to, internal to, and/or in a perforating gun 20 of, the actual perforating string 12.

Adjusting the shock model can include repeatedly: a) receiving a comparison of the predictions of the perforating effects to the measurements of the perforating effects, and b) adjusting the shock model 110 to reduce differences between the predictions of the perforating effects and the measurements of the perforating effects, until the differences are acceptably reduced.

The method may include, prior to the recording step, inputting a three dimensional geometrical model 114 of the actual perforating string 12 into the shock model 110.

The method may include, after the adjusting step and prior to the causing step, inputting a three dimensional model 114 of the proposed perforating string 12 into the shock model 110.

The predictions of the perforating effects can include stresses along the actual perforating string 12, motions along the actual perforating string 12, and/or interactions between the actual perforating string 12 and the wellbore 14. The interactions between the actual perforating string 12 and the wellbore 14 may include contact loads and friction between the actual perforating string 12 and the wellbore 14.

The above disclosure also describes a method 80 of predicting perforating effects on a perforating string 12 in a wellbore 14. The method 80 can include inputting a three dimensional well model 112 and a three dimensional model 114 of the perforating string 12 into a shock model 110; and causing the shock model 110 to predict the perforating effects on the perforating string 12.

The three dimensional model 114 of the perforating string 12 may include a model of one or more shock sensing tools 22 interconnected in the perforating string 12.

The three dimensional model 114 of the perforating string 12 may include material properties of components of the perforating string 12.

The method 80 can include measuring the perforating effects on the perforating string 12 caused by detonation of perforating guns 20.

The method 80 may include adjusting the shock model 110 so that the predicted perforating effects output by the shock model 110 substantially match the measurements of the perforating effects.

The perforating effects can include at least axial, bending and torsional strain in the perforating string 12. The perforating effects may include stresses along the perforating string 12, motions along the perforating string 12, and/or interactions between the perforating string 12 and the wellbore 14. The interactions between the perforating string 12 and the wellbore 14 can include contact loads and friction between the perforating string 12 and the wellbore 14.

It is to be understood that the various embodiments described herein may be utilized in various orientations, such as inclined, inverted, horizontal, vertical, etc., and in various configurations, without departing from the principles of the present disclosure. The embodiments are described merely as examples of useful applications of the principles of the disclosure, which is not limited to any specific details of these embodiments.

In the above description of the representative embodiments, directional terms, such as “above,” “below,” “upper,” “lower,” etc., are used for convenience in referring to the accompanying drawings. In general, “above,” “upper,” “upward” and similar terms refer to a direction toward the earth's surface along a wellbore, and “below,” “lower,” “downward” and similar terms refer to a direction away from the earth's surface along the wellbore.

Of course, a person skilled in the art would, upon a careful consideration of the above description of representative embodiments of the disclosure, readily appreciate that many modifications, additions, substitutions, deletions, and other changes may be made to the specific embodiments, and such changes are contemplated by the principles of the present disclosure. Accordingly, the foregoing detailed description is to be clearly understood as being given by way of illustration and example only, the spirit and scope of the present invention being limited solely by the appended claims and their equivalents.

What is claimed is:

1. A method of utilizing a shock model for prediction of perforating effects, the method comprising:
recording measurements of the perforating effects on an actual perforating string in a wellbore;
adjusting the shock model so that predictions of the perforating effects output by the shock model substantially match the measurements of the perforating effects; and
causing the adjusted shock model to predict the perforating effects for a proposed perforating string.

2. The method of claim 1, wherein the recorded measurements include axial, bending and torsional strain in the actual perforating string.

3. The method of claim 1, wherein the recorded measurements include pressure external to the actual perforating string.

4. The method of claim 1, wherein the recorded measurements include pressure internal to the actual perforating string.

5. The method of claim 1, wherein the recorded measurements include pressure internal to a perforating gun of the actual perforating string.

6. The method of claim 1, wherein adjusting the shock model further comprises repeatedly: a) receiving a comparison of the predictions of the perforating effects to the measurements of the perforating effects, and b) adjusting the shock model to reduce differences between the predictions of the perforating effects and the measurements of the perforating effects, until the differences are acceptably reduced.

7. The method of claim 1, further comprising, prior to the recording step, inputting a three dimensional geometrical model of the actual perforating string into the shock model.

8. The method of claim 1, further comprising, after the adjusting step and prior to the causing step, inputting a three dimensional model of the proposed perforating string into the shock model.

9. The method of claim 1, wherein the predictions of the perforating effects include stresses along the actual perforating string.

10. The method of claim 1, wherein the predictions of the perforating effects include motions along the actual perforating string.

11. The method of claim 1, wherein the predictions of the perforating effects include interactions between the actual perforating string and the wellbore.

12. The method of claim 11, wherein the interactions between the actual perforating string and the wellbore include contact loads and friction between the actual perforating string and the wellbore.

13. A method of predicting perforating effects on a perforating string in a wellbore, the method comprising:
inputting a three dimensional well model and a three dimensional model of the perforating string into a shock model; and
causing the shock model to predict the perforating effects on the perforating string.

14. The method of claim 13, wherein the three dimensional model of the perforating string includes a model of a shock sensing tool interconnected in the perforating string.

15. The method of claim 13, wherein the three dimensional model of the perforating string includes a model of multiple shock sensing tools interconnected in the perforating string.

16. The method of claim 13, wherein the three dimensional model of the perforating string includes material properties of components of the perforating string.

17. The method of claim 13, further comprising measuring the perforating effects on the perforating string caused by detonation of perforating guns.

18. The method of claim 17, further comprising adjusting the shock model so that the predicted perforating effects output by the shock model substantially match the measurements of the perforating effects.

19. The method of claim 13, wherein the perforating effects include at least axial loads in the perforating string.

20. The method of claim 19, wherein the perforating effects further include bending loads in the perforating string.

21. The method of claim 20, wherein the perforating effects further include torsional loads in the perforating string.

22. The method of claim 13, wherein the perforating effects include stresses along the perforating string.

23. The method of claim 13, wherein the perforating effects include motions along the perforating string.

24. The method of claim 13, wherein the perforating effects include interactions between the perforating string and the wellbore.

25. The method of claim 24, wherein the interactions between the perforating string and the wellbore include contact loads and friction between the perforating string and the wellbore.
